(19) United States
(12) Patent Application Publication
(10) Pub. No.: US 2023/0025635 A1
(43) Pub. Date: Jan. 26, 2023

(54) NOVEL ARCHED COMMUTATOR STRUCTURE OF BRUSH DIRECT CURRENT MOTOR

(71) Applicant: Xi'an Si Special Transmission Manufacturing Co., Ltd., Xi'an (CN)

(72) Inventors: Guang Chen, Xi'an (CN); Xiaofei Huo, Xi'an (CN); Jichun Xue, Xi'an (CN); Xuefeng Pan, Xi'an (CN); Wei Sun, Xi'an (CN)

(21) Appl. No.: 17/740,003

(22) Filed: May 9, 2022

(30) Foreign Application Priority Data
Jul. 26, 2021 (CN) 202110845977.3

(51) Int. Cl. H02K 13/00; H02K 13/10; H02K 5/14

(52) U.S. Cl. CPC H02K 13/006; H02K 13/10; H02K 5/143

(57) ABSTRACT

The disclosure discloses a novel arched commutator structure of a brush direct current motor, which comprises a round nut or a bolt, a pressing ring, a reinforcing ring, a sleeve, a commutator segment group and a mica ring. The effective part of the arched commutator is the commutator segment group consisting of commutator segments with V-shaped gaps at two ends and mica sheets; and the V-shaped groove of the commutator segment group is clamped by the V-shaped cone part of the pressing ring at one end and the V-shaped cone part of the sleeve at the other end. The advantages are: the deformation of the commutator caused by various acting forces generated in the operation process of the motor can be reduced and even prevented; the economic benefit generated every year cannot be estimated by taking a hundred million as a unit; materials are saved; the production cost is reduced.

### 1. TECHNICAL FIELD

The invention relates to a motor, in particular to a novel arched commutator structure of a brush direct current motor.

### 2. BACKGROUND ART

The commutator is an extremely important and complex part of the DC motor, and its quality directly affects the performance and service life of the motor. The structure of the arched commutator is usually composed of a pressing ring with a V-shaped cone, a mica ring, a commutator segment group composed of commutator segments and mica sheets, a sleeve with a V-shaped cone, a bolt or a round nut. During the operation of the motor, it not only rotates, but also rubs against the brushes, and at the same time bears the effects of thermal deformation and centrifugal force, especially in the extreme working environment (frequent overload, overspeed, high speed, poor ventilation) of the motor, the quality of the commutator is higher. The protrusion and deformation of the commutator is the main reason for the damage and scrapping of the motor.

### 3. SUMMARY OF THE INVENTION

The technical problem to be solved by the invention is the protrusion and deformation of the commutator during use, and the protrusion and deformation of the commutator is one of the main reasons for the damage of the existing DC motor.

In order to solve the above technical problems, the technical solutions provided by the invention are: a novel arched commutator structure of a brush direct current motor, comprising a round nut or a bolt, a pressing ring, a reinforcing ring, a sleeve, a commutator segment group, and a mica ring, wherein the effective part of the arched commutator is the commutator segment group consisting of commutator segments with V-shaped gaps at two ends and mica sheets; the V-shaped groove of the commutator segment group is clamped by the V-shaped cone part of the pressing ring at one end and the V-shaped cone part of the sleeve at the other end; the V-shaped mica ring is provided between the commutator segment group, the pressing ring, and the sleeve; the sleeve pressing ring is fastened by the specially made round nut or bolt, and the commutator segment group is fixed at the same time the commutator is in a fastened state as a whole;

the commutator segment group is provided with one, two, or more than two special-shaped notches, and the special-shaped notches can reduce centrifugal force; the reinforcing ring is added in the closed annular groove formed by the special-shaped notches, and the reinforcing ring has the functions of resisting centrifugal force and resisting the deformation of the commutator segment group.

The advantages of the invention compared with the prior art are: 1) the deformation of the commutator caused by various acting forces generated in the operation process of the motor can be reduced and even prevented to the greatest extent, the quality stability of the commutator is improved, and meanwhile, the performance and the service life of the motor are stabilized; the economic benefit generated every year cannot be estimated by taking a hundred million as a unit;

2) the invention will perfectly replace and surpass similar imported products;

3) the production cost is reduced and resources are saved.

As an improvement, after the commutator segment group is assembled, the reinforcing ring is formed by filling, so that the material can fully fill the annular groove inside the commutator segment group, which enhances internal strength and stability, reduces deformation and resists centrifugal force of the commutator segment group during operation.

As an improvement, special high-strength insulating material is selected for filling in the annular groove of the commutator segment group.

As an improvement, the annular groove structure types of the commutator segment group include trapezoidal notches, T-shaped notches, circular notches and elliptical notches.

### 4. BRIEF DESCRIPTION OF ACCOMPANY DRAWINGS

FIG. 1 is a schematic structural diagram of the novel arched commutator structure of a brush FIG. 2 is a schematic structural diagram of the novel arched commutator structure of a brush direct current motor according to the invention when a bolt is adopted.

FIG. 3 is a schematic structural diagram of the trapezoidal notch of the commutator segment according to Embodiment 1.

FIG. 4 is a schematic structural diagram of the T-shaped notch of the commutator segment according to Embodiment 2.

FIG. 5 is a schematic structural diagram of the circular notch of the commutator segment according to Embodiment 3.

FIG. 6 is a schematic structural diagram of the elliptical notch of the commutator segment according to Embodiment 4.

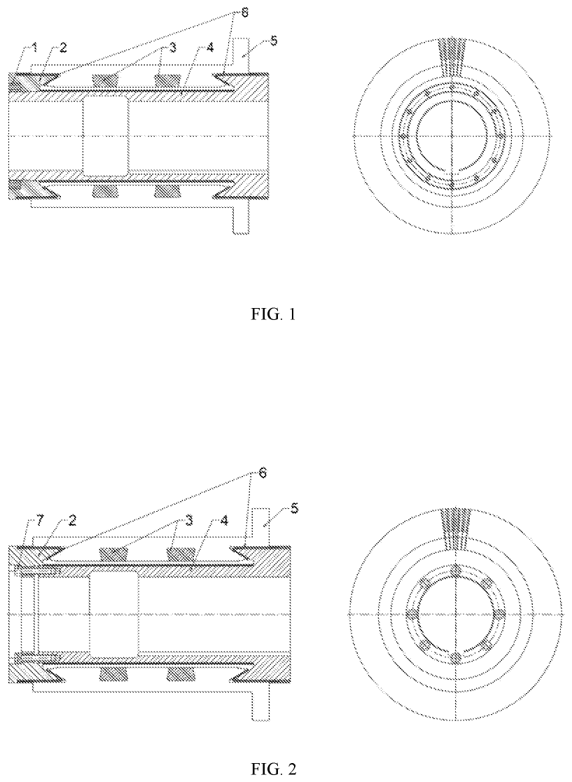

As shown in the figures, 1 refers to the round nut; 2 refers to the pressing ring; 3 refers to the reinforcing ring; 4 refers to the sleeve; 5 refers to the commutator segment group; 6 refers to the mica ring; 7 refers to the bolt.

### 5. SPECIFIC EMBODIMENT OF THE INVENTION

The invention will be further described in detail hereinafter with reference to the drawings.

When the invention is in specific implementation, a novel arched commutator structure of a brush direct current motor, comprising a round nut 1 or a bolt 7, a pressing ring 2, a reinforcing ring 3, a sleeve 4, a commutator segment group 5, and a mica ring 6, wherein the effective part of the arched commutator is the commutator segment group 5 consisting of commutator segments with V-shaped gaps at two ends and mica sheets; the V-shaped groove of the commutator segment group 5 is clamped by the V-shaped cone part of the pressing ring 2 at one end and the V-shaped cone part of the sleeve 4 at the other end; the V-shaped mica ring 6 is provided between the commutator segment group 5, the pressing ring 2, and the sleeve 4; the sleeve pressing ring is fastened by the specially made round nut 1 or bolt 7, and the commutator segment group 5 is fixed at the same time the commutator is in a fastened state as a whole;

the commutator segment group 5 is provided with one, two, or more than two special-shaped notches, and the special-shaped notches can reduce centrifugal force; the reinforcing ring 3 is added in the closed annular groove formed by the special-shaped notches, and the reinforcing ring 3 has the functions of resisting centrifugal force and resisting the deformation of the commutator segment group.

After the commutator segment group 5 is assembled, the reinforcing ring 3 is formed by filling, so that the material can fully fill the annular groove inside the commutator segment group 5, which enhances internal strength and stability, reduces deformation and resists centrifugal force of the commutator segment group during operation.

Special high-strength insulating material is selected for filling in the annular groove of the commutator segment group.

The annular groove structure types of the commutator segment group 5 include trapezoidal notches, T-shaped notches, circular notches and elliptical notches.

The working principle of the invention: the device is a novel arched commutator structure of a brush direct current motor, comprising a steel sleeve, a steel V-shaped pressing ring, a mica ring, a commutator segment group consisting of commutator segments and mica sheets, a commutator consisting of a steel bolt or a steel round nut; a special-shaped notch is added to the commutator segment group, and a reinforcing ring that resists the deformation of the commutator and the centrifugal force is filled in the special-shaped notch.

The commutator segment is added with one or more than two special-shaped notches to reduce centrifugal force; a reinforcing ring capable of resisting centrifugal force and resisting the deformation of the commutator segment group is added in the closed annular groove of the commutator segment group, and the process steps are: 1) first, assemble the prepared commutator segments and mica sheets with special-shaped notches and then fill (high mechanical strength insulating material) in a special way; 2) the insulating material fully fills the annular groove inside the commutator segment group, which enhances internal strength and stability, reduces deformation and resists centrifugal force of the commutator segment group during operation.

Round nuts and bolts can be selected according to the actual situation, and both can be used.

### Embodiment 1

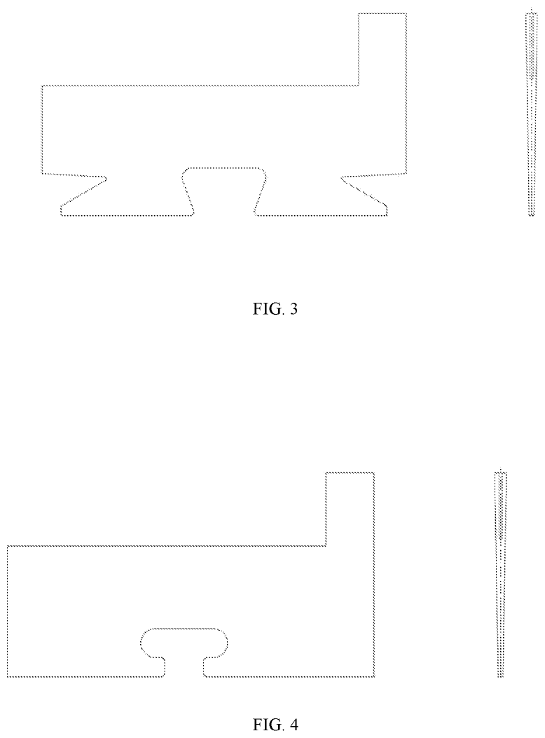

The embodiment proposes a schematic structural diagram of the commutator segment, and the special-shaped groove adopts a trapezoidal notch structure, as shown in FIG. 3.

### Embodiment 2

The embodiment proposes a schematic structural diagram of the commutator segment, and the special-shaped groove adopts a T-shaped notch structure, as shown in FIG. 4.

### Embodiment 3

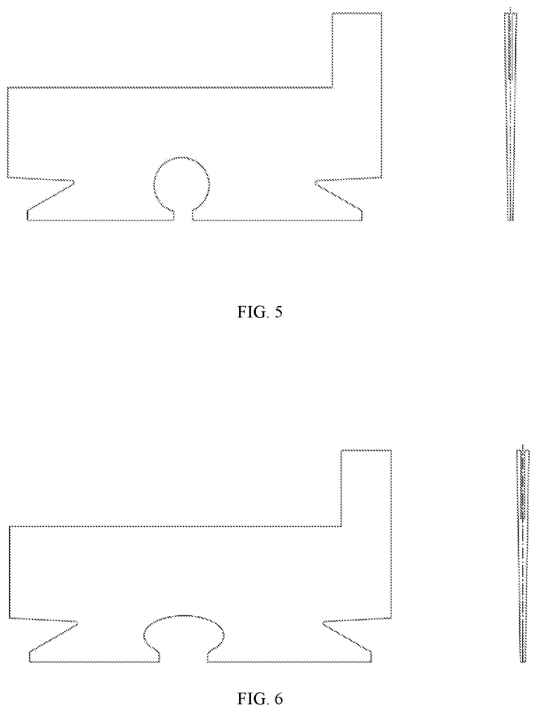

The embodiment proposes a schematic structural diagram of the commutator segment, and the special-shaped groove adopts a circular notch structure, as shown in FIG. 5.

### Embodiment 4

The embodiment proposes a schematic structural diagram of the commutator segment, and the special-shaped groove adopts an elliptical notch structure, as shown in FIG. 6.

In addition, terms such as “first”, “second”, etc. in the invention are only for descriptive purposes, and should not be construed as indicating or implying their relative importance or implicitly indicating the number of indicated technical features. Thus, a feature delimited with “first”, “second” may expressly or implicitly include at least one of that feature. In the description of the invention, “plurality” means two or more, unless otherwise expressly and specifically defined.

In the invention, unless otherwise clearly defined and limited, the terms “installed”, “connected”, “fixed” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements, unless specifically defined otherwise. For those of ordinary skill in the art, the specific meaning of the above terms in the invention can be understood according to specific circumstances.

In the invention, unless otherwise clearly defined and limited, the first feature is “above” or “below” the second feature can be that the first feature and the second feature are in direct contact, or the first feature and the second feature are not in direct contact but in contact with another feature between them. Moreover, the first feature is “above”, “over”, and “in the upper of” the second feature can be that the first feature is directly above and obliquely above the second feature, or only that the level of the first feature is higher than that of the second feature. The first feature is “below”, “under”, and “in the lower of” the second feature can be that the first feature is directly below and obliquely below the second feature, or only that the level of the first feature is lower than that of the second feature.

In the description of the specification, description with reference to the terms “one embodiment”, “some embodiments”, “examples”, “specific examples”, or “some examples” etc. means that the specific features, structures, materials, or characteristics described in conjunction with the embodiments or examples are included in at least one embodiment or example of the invention. In the specification, the schematic representation of the above terms does not necessarily refer to the same embodiment or example. Moreover, the described specific features, structures, materials or characteristics may be combined in any one or more embodiments or examples in a suitable manner.

Although the embodiments of the invention have been shown and described hereinabove, it can be understood that the above embodiments are exemplary and should not be understood as limiting the invention. Those of ordinary skill in the art can make changes, modifications, substitutions and variations to the above embodiments within the scope of the invention without departing from the principle and purpose of the invention.

1. A novel arched commutator structure of a brush direct current motor, comprising a round nut (1) or a bolt (7), a pressing ring (2), a reinforcing ring (3), a sleeve (4), a commutator segment group (5), and a mica ring (6), wherein the effective part of the arched commutator is the commutator segment group (5) consisting of commutator segments with V-shaped gaps at two ends and mica sheets; the V-shaped groove of the commutator segment group (5) is clamped by the V-shaped cone part of the pressing ring (2) at one end and the V-shaped cone part of the sleeve (4) at the other end; the V-shaped mica ring (6) is provided between the commutator segment group (5), the pressing ring (2), and the sleeve (4); the sleeve pressing ring is fastened by the specially made round nut (1) or bolt (7), and the commutator segment group (5) is fixed at the same time the commutator is in a fastened state as a whole;
the commutator segment group (5) is provided with one, two, or more than two special-shaped notches, and the special-shaped notches can reduce centrifugal force; the reinforcing ring (3) is added in the closed annular groove formed by the special-shaped notches, and the reinforcing ring (3) has the functions of resisting centrifugal force and resisting the deformation of the commutator segment group.

2. The novel arched commutator structure of a brush direct current motor of claim 1, wherein after the commutator segment group (5) is assembled, the reinforcing ring (3) is formed by filling, so that the material can fully fill the annular groove inside the commutator segment group (5), which enhances internal strength and stability, reduces deformation and resists centrifugal force of the commutator segment group during operation.

3. The novel arched commutator structure of a brush direct current motor of claim 2, wherein special high-strength insulating material is selected for filling in the annular groove of the commutator segment group (5).

4. The novel arched commutator structure of a brush direct current motor of claim 1, wherein the annular groove structure types of the commutator segment group (5) include trapezoidal notches, T-shaped notches, circular notches and elliptical notches.
